(19) United States
(12) Patent Application Publication
(10) Pub. No.: US 2011/0143839 A1
(43) Pub. Date: Jun. 16, 2011

(54) EXERCISE CONTROL DEVICE FOR VIDEO GAMES

(76) Inventor: Thomas McLaughlin, Briarcliff Manor, NY (US)

(21) Appl. No.: 13/024,399

(22) Filed: Feb. 10, 2011

Related U.S. Application Data
(63) Continuation-in-part of application No. 12/325,295, filed on Dec. 1, 2008, now abandoned.

(51) Int. Cl. A63F 13/06

(52) U.S. Cl. 463/37

(57) ABSTRACT

An exercise control device adapted to be activated by vigorous exercises such as push-ups and leg squats comprises a joystick having electronic outputs for controlling the movement of an element of a video game. An elongated tether is connected at one end to the joystick and at its opposite end to the body of a user whereby lateral movements of the user's body cause movement of the video game element dependent on the direction of such lateral movement. Movement of the user's body transverse to such lateral movements controls switches in the joystick whereby both lateral and transverse movements of the user can be used to play the video game. A pair of controlled input devices produce signals which can also be used in playing the video games. Such devices may be operated by the user's hands or feet.

### CROSS-REFERENCE TO RELATED APPLICATIONS

This is a Continuation In Part of U.S. patent application Ser. No. 12/325,295, filed Dec. 1, 2008, and entitled RIDING THE JOYSTICK SYSTEM TO HEALTH AND FITNESS. application Ser. No. 12/325,295 is hereby incorporated by reference into this specification.

### BACKGROUND

This invention relates to an exercise system, and in particular, to an exercise controlled device to be used in playing a video game. The purpose of the invention is to encourage individuals to engage in vigorous exercise by enabling game playing through exercise.

It is beyond dispute that exercise is beneficial for virtually everybody. Whether the purpose is fitness, weight control or rehabilitation, everyone benefits from a well conceived exercise program faithfully carried out throughout a person's life. Despite the acknowledged benefits from vigorous exercise, many, if not most, people find it difficult to maintain an exercise program for a prolonged period of time. There are many reasons for this. Some people find exercise dull if not boring; others may find it difficult to travel to facilities where exercise equipment is available. In an attempt to resolve these and other well recognized problems, manufacturers of video games have developed systems which can be used at home and which enable the users to play many different sports in such a way that the user can enjoy a prolonged and healthy workout. These known devices, however, require sophisticated electronic input/output devices and as a result are costly.

### OBJECTS OF THE INVENTION

The principal object of the invention is to provide a device which will make vigorous exercise entertaining for most people, thus encouraging them to maintain an exercise program and thereby enjoy the benefits of exercise.

Another object of the invention is to provide a device which enables a user to play video games by means of well accepted exercises.

A further object of the invention is to provide a relatively inexpensive joystick controlled video game in which strenuous movements of the user's body are used to play a video game.

### SUMMARY OF THE INVENTION

The invention includes a joystick control device which controls a cursor on a video monitor. The joystick is connected to the user by a tether in such a way that movements of the user's body control the cursor. In a preferred embodiment, an elastic tether connects the user's body to the joystick. Lateral movements of the user move the cursor in two dimensions on the screen. Up and down movements of the user actuate switches in the joystick control for further control of the cursor. Additional units which may be operated by the user's hands or feet provide still additional control of the video cursor as the user is exercising. In the preferred embodiment, the invention is designed to be used in conjunction with push-ups and squats, two highly beneficial vigorous exercises. As a user exercises, simultaneously he or she plays a video game by controlling the movement of the video cursor.

### THE DRAWINGS

FIG. 1 is a perspective view showing an exercise actuated apparatus for playing a video game in accordance with the preferred embodiment of the invention;

FIGS. 1A and 1B are schematic views of a user doing a push-up to play the game;

FIGS. 2A and 2B are schematic views showing a user shifting his/her weight left and right, respectively, to play the game;

FIGS. 3A and 3B show a user moving his/her weight forward and backward, respectively, to play the game;

FIGS. 4A and 4B show a user doing a squat to play the game;

FIGS. 5A and 5B show a user moving his/her weight left and right, respectively, to play the game;

FIGS. 6A and 6B show a user moving backwards and forwards, respectively, to play the game;

FIGS. 7A-7C are explanatory illustrations of a video monitor showing how a representative game can be played in accordance with the invention;

FIG. 8 is an exploded perspective view of the apparatus shown in FIG. 1;

FIG. 9 is a front view showing an elastic tether and illustrative connector means;

FIG. 10 is a magnified view of detail A in FIG. 9;

FIG. 11 is a perspective view of a top clip;

FIG. 12 is a magnified view of detail B in FIG. 11;

FIG. 13 is a side view of the joystick control and the tether connector;

FIG. 14 is a front view of the joystick control and tether connector;

FIG. 15 is a top view of the joystick control and tether connector;

FIG. 16 is a sectional view along the line C-C of FIG. 15;

FIG. 17 is a top view of the joystick control and tether connector;

FIG. 18 is an enlarged view of detail E in FIG. 19;

FIG. 19 is a sectional view along the line D-D of FIG. 17;

FIG. 20 is an exploded perspective view of the joystick control and tether connector;

FIG. 21 is a top view of a foot adaptor and rotary input device according to a preferred embodiment of the invention;

FIG. 22 is a sectional view along the line F-F of FIG. 21;

FIG. 23 is an enlarged view of detail G in FIG. 22;

FIG. 24 is an exploded side view showing the foot adaptor and rotation unit according to the preferred embodiment; and

FIG. 25 is a bottom view of the rotation unit with the bottom cover and supporting feet removed.

### DETAILED DESCRIPTION

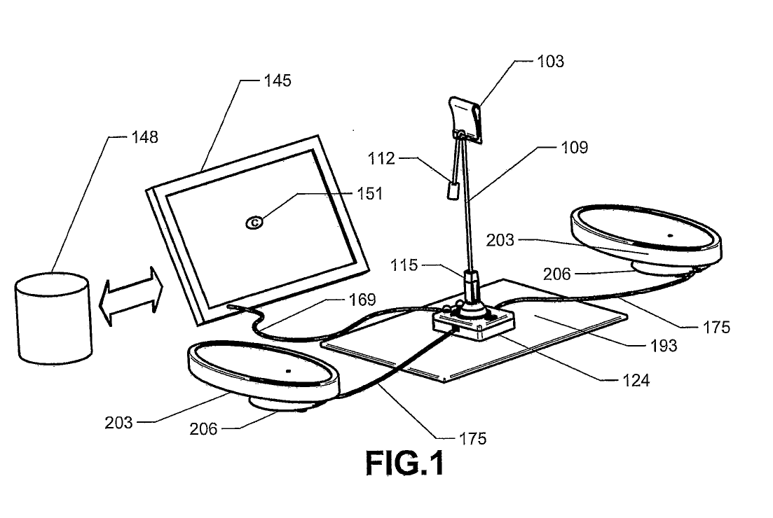

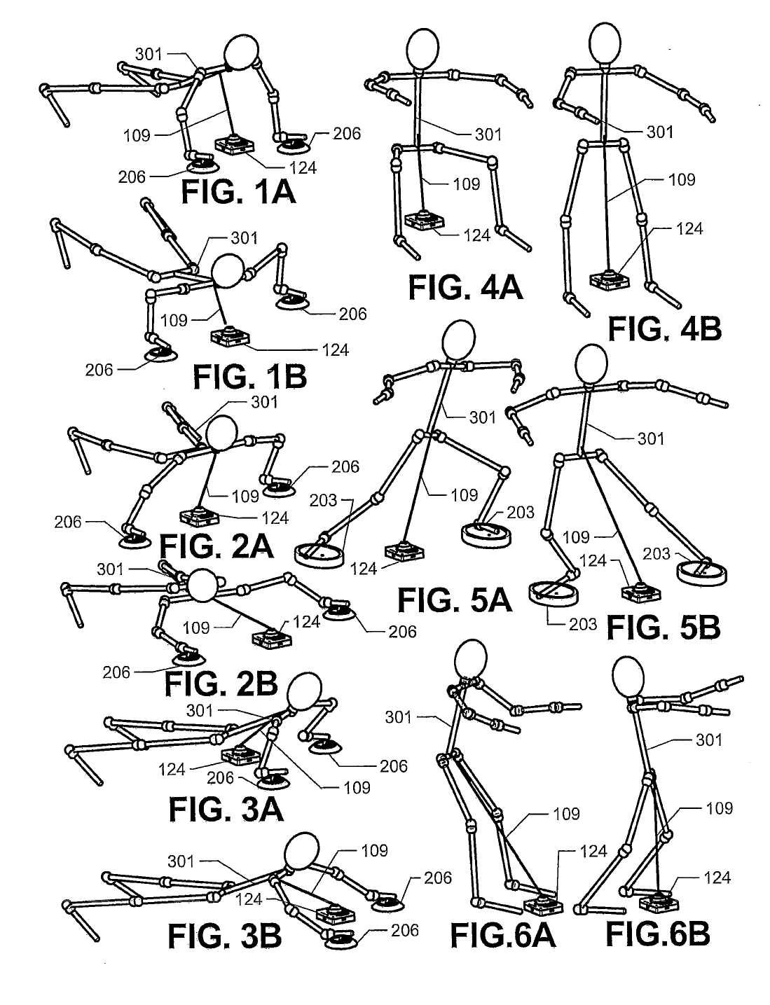

The basic invention is described below with reference to FIGS. 1-7. FIG. 1 shows diagrammatically the components of the invention that are used to play a video game.

The essential element of the invention is a joystick control 124. Such devices are well known and are commonly used to play video games. A joystick is an input device which includes a stick that pivots in two dimensions and produces electrical signals corresponding to the position of the stick. When used to control a video game, the position of the stick determines the horizontal and vertical position of a cursor on a video monitor. It is customary for the joystick to also include one or more push buttons, the state of which can be read by a computer in order to play the game. In FIG. 1, the video monitor is shown at 145 and the cursor on the video screen is shown at 151. The video display software for the video game is represented schematically by the cylinder 148. Such software is known and forms no part of this invention.

In accordance with a preferred embodiment of the invention, the joystick control 124 is controlled by means of an elastic tether 109 which can be attached to the clothing of a user by means of a top clip 103. As the elastic tether 109 is moved by the user during exercise, e.g. push-ups and squats, the joystick control 124 moves to control the position of cursor 151 on the video monitor 145, the joystick control 124 being connected to the video game computer by means of a cable 169. As explained below, the joystick control 124 is also responsive to vertical movements of the stretchable elastic tether 109, such vertical movements actuating an on/off switch comparable to the push button switches in standard joysticks. In operation, the elastic tether 109 is stretched, i.e. under tension, so that as the user's body moves, the joystick moves similarly to generate control signals which control the game.

In addition to the joystick control 124, two rotary input devices 206 are provided. Depending on the position of each rotary input device 206, signals are coupled through the joystick control 124 to the video display software 148 to control the display on the monitor 145. In the preferred embodiment, foot adapters 203 may be placed on top of the rotary input devices 206 so that the user can control the rotary input devices 206 by means of foot rotation or hand rotation.

The invention is not restricted to specific exercises but two exercises which are particularly beneficial are push-ups and squats. For purposes of explanation, these exercises will be used as examples of exercises that can be used in accordance with the invention. The exercises are illustrated diagrammatically in FIGS. 1A-6B.

FIGS. 1A to 6B illustrate a number of static positions of a body 301 while engaged in playing a video game. In practice, movement of the body 301 would be dynamic, essentially rotating and shifting with movements flowing from one position to another. It is this flow of position changes that results in the strengthening of connective muscles surrounding bodily joints. Equally important, the continual stretching needed to reposition the user's body weight provides frequent and controlled joint manipulation thus causing progressive elongation of the connective tissue to increase the user's range of motion.

FIGS. 1A and 1B show a user in a plank position doing a push up. In FIG. 2A, the user shifts her weight to the left and in FIG. 2B her weight is shifted to the right. In FIG. 3B the user shifts her weight forward and in FIG. 3B her weight is shifted backwards. In each case, the joystick control 124 is connected to the user by means of the elastic tether 109; thus, as the user moves in any horizontal direction, the joystick control 124 moves accordingly, producing a signal which moves the cursor 151 on the monitor 145 (FIGS. 1, 7A-7C, and 8) in a conventional fashion. Note also that the user's hands are placed on the rotary input devices 206 so that the user has the ability of rotating these devices to produce additional control signals for display purposes on the monitor 145 (FIGS. 1, 7A-7C, and 8).

In a similar context, FIGS. 4A-6B shows a user performing squat exercises. Again the user is tethered to the joystick control 124 by means of the elastic tether 109 and can move left or right (FIGS. 5A and 5B) or backwards and forward (6A and 6B) to control the joystick and consequently the cursor 151 (FIGS. 1, 7A-7C, and 8).

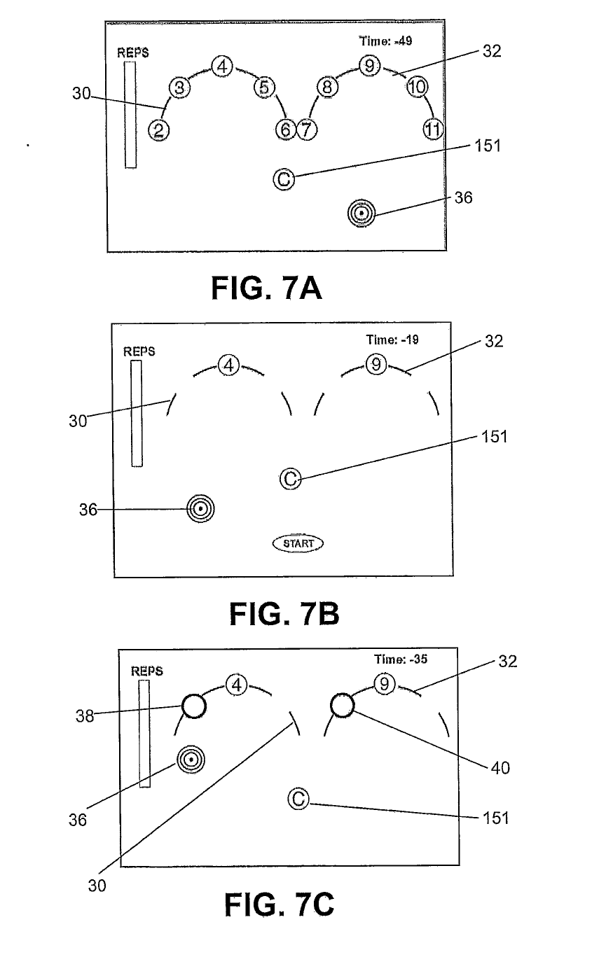

To understand the invention, it is helpful to consider an example of a simple video game that can be played by a user while performing either push-ups or squats as shown in FIGS. 1A-6B. Obviously, the specific game is not a feature of the invention but one representative type of game is shown in FIGS. 7A-7C for purposes of explanation only.

When the device turns on, the screen shown in FIG. 7A may be displayed. This screen consists of a column labeled REPS, arcs 30 and 32, the cursor 151 and a target 36. The REPS column accumulates the number of times a goal oriented feat is accomplished. A Time indicator in the upper right hand corner reflects the amount of time that has expired since the device has started. Each of the arcs 30 and 32 includes five possible positions which correspond to five discreet positions of the two rotary input devices 206 (numbered “2” through “6” and “7” through “11”, respectively). During the actual game, only one numbered circle appears in each of the two arcs at any one time. Movement of the cursor 151 corresponds to the joystick position and therefore is controlled by the movements of the user during game play. The target element 36 travels constantly and randomly across the video display during the game.

The joystick control 124 includes a switch which is responsive to vertical movement of the user. When the user's body moves downwardly, the cursor is activated, i.e. the cursor is placed under the control of the joystick. At the same time, a start oval appears on the screen (FIG. 7B). To start the game, the user moves his/her body in such a way as to position the cursor 151 over the start oval (FIG. 7B) and then institutes a downward motion sufficient to activate the cursor. This will be comparable to using a mouse to move a cursor to the start oval and when the two are aligned, clicking the left mouse button.

Each of the rotary input devices 206 sends information to the joystick control representing the rotary position of the device. In this example, each rotary input device 206 has five separate positions. In FIG. 7B, the user's hands are pointed in a forward direction causing the numbers “4” and “9” to be displayed in the center of the arcs 30 and 32.

The video display now randomly displays a pair of open circles 38 and 40 within the arcs 30 and 32, respectively. In FIG. 7C, the circles 38 and 40 are in positions “3” and “8”. The user must then rotate each hand counterclockwise a distance sufficient to display the numbers “3” and “8” within the open circles 38 and 40.

In this case, the goal oriented feat (recorded as a REP) is to position the proper number within the targeted open circles 38 and 40 while at the same time moving the cursor 151 to intersect the randomly moving target 36. At the same time, the user must move downwardly to activate the cursor. When all three conditions are met, a new pair of open circles 38, 40 is placed randomly within the two arcs 30 and 32. When this occurs, the timer indicates the amount of time that has elapsed since the game started and the REPS count is incremented by one. A game is complete when a user has accumulated 20 REPS, the elapsed time indicating how well the game was played.

Hence, in the course of playing a video game, a user performs pushup or squat exercises and simultaneously repositions the orbital orientation of the hands or feet. The combined motions dramatically increase muscular and connective tissue involvement and thus the extent of fitness development, particularly in the upper body. These exercise routines are time-tested and universally acclaimed by health professionals and exercise experts as being among the best to perform for improved health and physical development. All of the user's motions are collected and transmitted via a joystick-like mechanism as if it was being operated by hand.

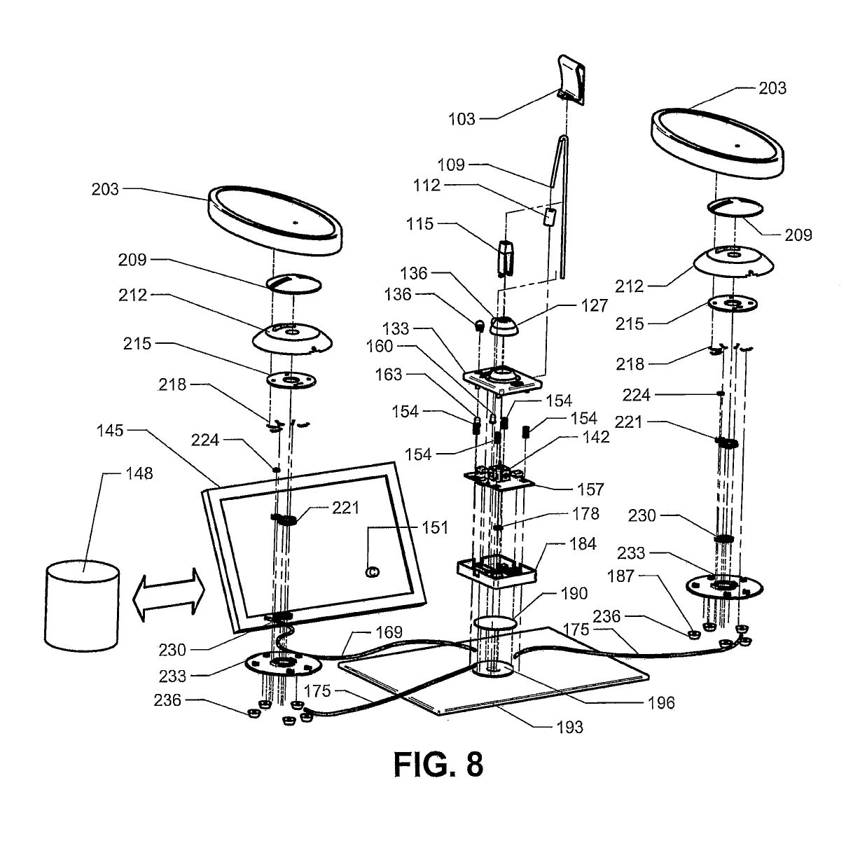

FIG. 8 is an exploded view of FIG. 1. In addition to the main components previously mentioned, the joystick control 124, is composed of a loop pad 190, a printed circuit board (PCB) bottom housing 184, a trigger switch 178, a main circuit board 157, a joystick 142, a set of four PCB springs 154, a green LED 163, a red LED 160, a PCB top housing 133, a pair of LED lenses 136, and a pivoting dome 127. In addition, a hook pad 196 is shown atop a base unit 193.

Also shown in FIG. 8 are the two rotary input devices 206 exploded upwards, with components illustrated from bottom to top for each being a set of five feet 236, a bottom cover 233, a spring 230, a magnet arm 221, a magnet 224, a set of reed switches 218, a circuit board 215, a housing 212, and a knob 209. The foot adapter 203 essentially attaches to the top of the knob 209.

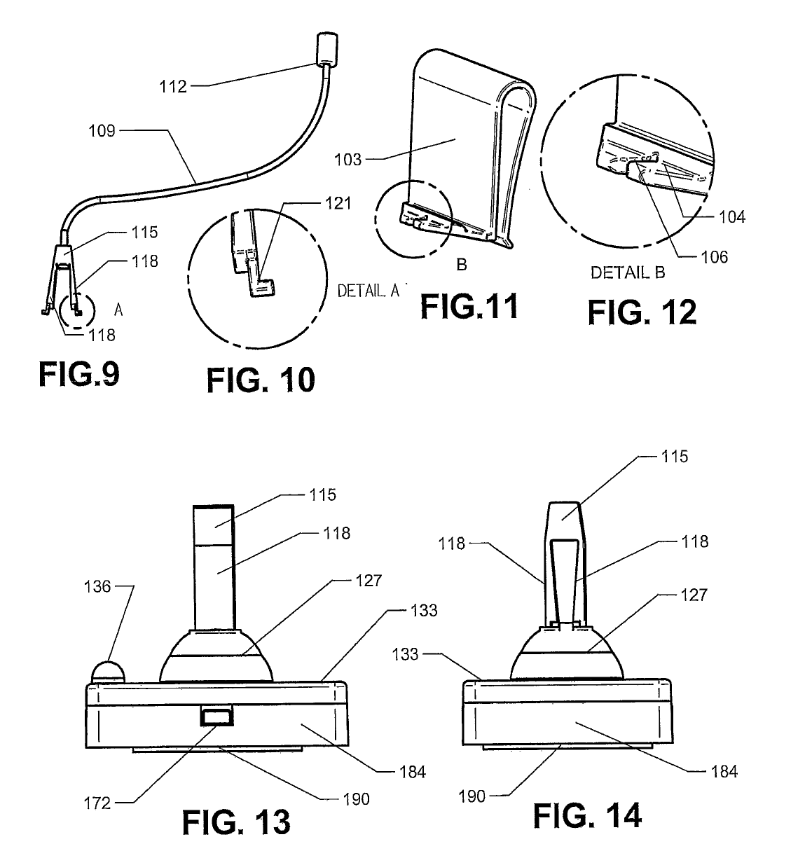

FIGS. 9 to 12 detail the parts that provide the connection between the user and the main control 124. In FIG. 9 a pair of link connector arms 118 is shown as part of the link connector 115. In FIG. 10 (detail A, from FIG. 9), one of two link connector latches 121 is show protruding from the bottom end of a link connector arm 118. FIG. 11 is an illustration of the top clip 103 with a detail B (FIG. 12) of a top clip hole 104 and a top clip slot 106.

The elastic tether 109 may be made of a highly stretchable tube formulated to maintain its original shape. A latex silicone rubber composition that maintains its shape can be used. Attached at the top of the elastic tether 109 is the top clip 103 (FIGS. 1, 8 and 11). The top clip 103 is designed to readily attach to the user's belt or clothes during operation. Designed into the top clip 103 are a top clip hole 104 and a top clip slot 106 (FIG. 12, detail B). The elastic tether 109 is threaded through top clip hole 104 and then bent over to be essentially tightly squeezed into top clip slot 106. This provides the means to readily fix the elastic tether 109 at varying lengths to accommodate users of differing stature and to vary the intensity of the exercise routines based upon the distance that the body 301 must be lowered to change the state of the trigger switch 178 (FIGS. 16, 19 and 20) during pushup-like and squat-like exercises.

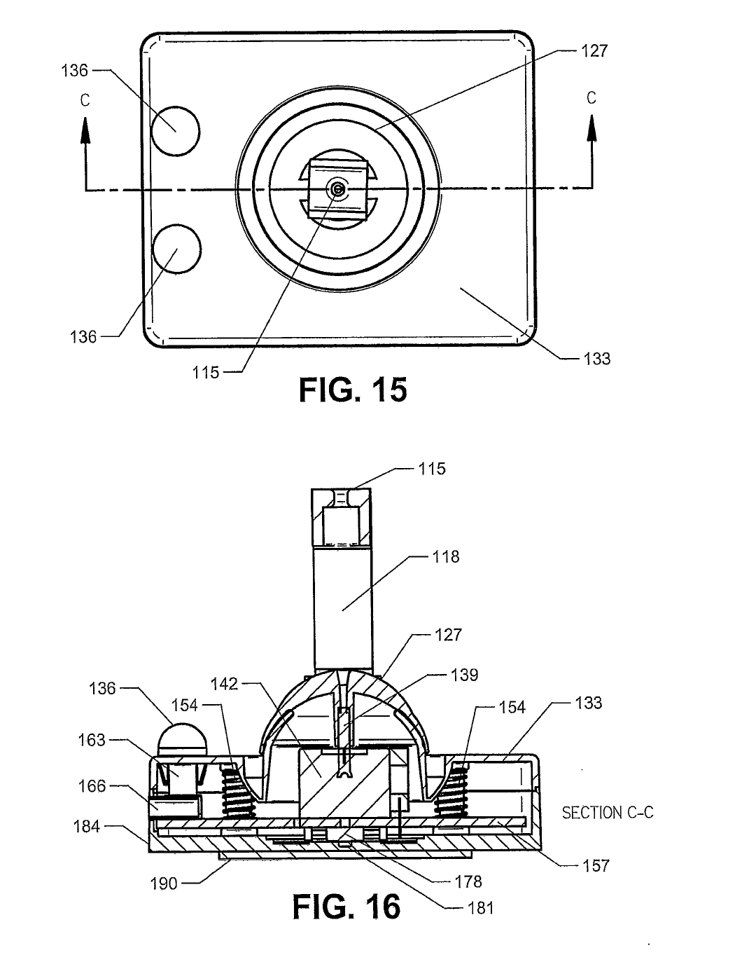

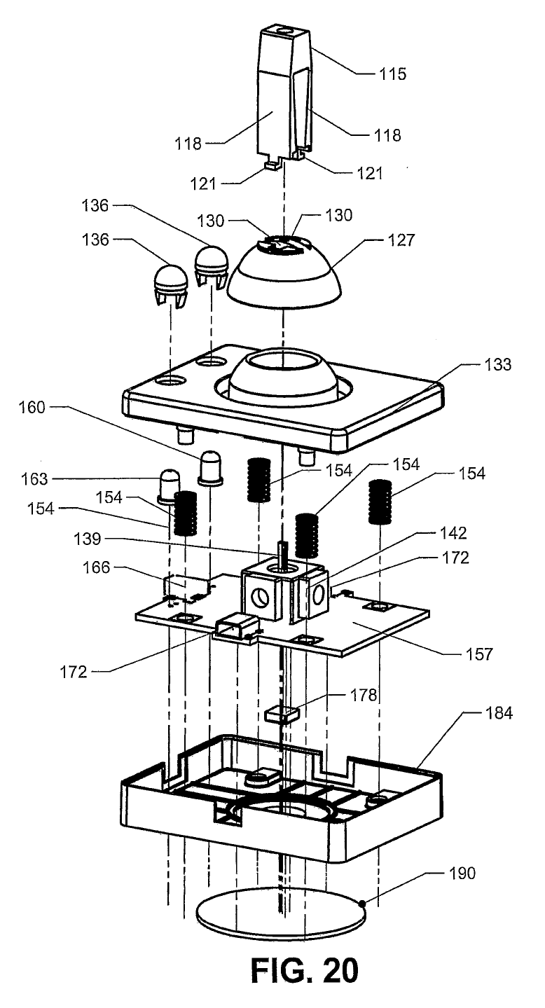

The purpose of the link end 112 (FIG. 9) shown at the top end of the elastic tether 109, is to prevent the elastic tether 109 from exiting the top clip 103. Attached at the lower end of the elastic tether 109 is the link connector 115, illustrated in FIGS. 1, 8, and 13 to 20. The link connector 115 has bendable protrusions referenced as a pair of link connector arms 118 (FIGS. 14 and 18 to 20) each having the link connector latch 121 at its lower end (FIGS. 10, 18 and 20). The user squeezes inward by the link connector arms 118 so that the link connector latches 121 can be positioned to enter the pivoting dome slots 130 (FIGS. 18 and 20). At this point, the release of the link connector arms 118 causes them to spring outwards to their original shape allowing the link connector latches 121 to become securely positioned within the pivoting dome slots 130 thus latching the link connector 115 to the pivoting dome 127 (FIGS. 8, 13, 14, 16, and 18 to 20).

FIG. 13 is a side view of the main control 124 showing the position of the loop pad 190, a rotate unit connector 172, the PCB bottom housing 184, the PCB top housing 133, the LED lens 136, the pivoting dome 127, and the link connector arm 118 of the link connector 115. FIG. 14 illustrates an end view of the main control 124 showing the same relationships as shown in FIG. 13 as well as a side view of the link connector arms 118 of the link connector 115.

FIG. 15 is a top view of the main control 124. The position of the LED lens 136 and the pivoting dome 127 are shown relative to the PCB top housing 133. FIG. 16 is a cross sectional view along line C-C of the main control 124 and the link connector 115. In addition to the component already shown in previous Figures, FIG. 16 illustrates a video display connector 166, a trigger switch button 181 and a joystick arm 139. As illustrated, the PCB springs 154 press down on the main circuit board 157 compressing the trigger switch button 181 onto the upper surface of the PCB bottom housing 184, thus transferring the trigger switch 178. The design of the PCB top housing 133 allows the pivoting dome 127 to freely pivot the joystick arm 139 in any direction.

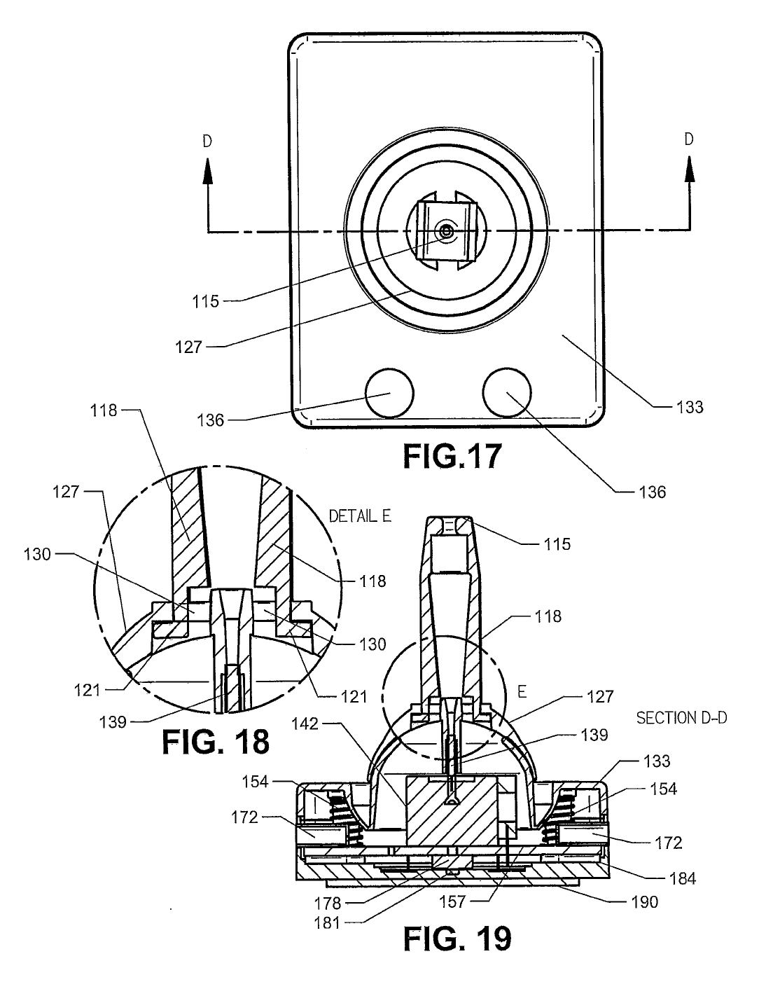

FIG. 17 is a top view of the main control 124. The position of the LED lens 136 and the pivoting dome 127 are shown relative to the PCB top housing 133. FIG. 19 is a cross sectional back view along line D-D of the main control 124 and the link connector 115. FIG. 18 is a detail view E from FIG. 19 illustrating a pair of pivoting dome slots 130 into which the link connector latches 121 attach the link connector arms 118 to the pivoting dome 127. As already shown in FIG. 16, FIG. 19 illustrates the internal structure of the main control 124. The two rotate unit connectors 172 are also shown. FIG. 20 is an exploded view of the main control 124 and the link connector 115.

The main control 124 is pivotally connected to the link 109 and provides a vertical mechanical connection to the trigger switch 178 (FIGS. 8, 16, 19, and 20) as well as electronic connectivity with both the video display software 148, which controls the video display 145, and the two rotary input devices 206.

The loop pad 190 (FIGS. 8, 13, 14, 16, 19, and 20) that is glued to the bottom of the main control 124 keeps the main control 124 firmly in place by temporarily attaching the main control 124 to the hook pad 196 glued to the base unit 193 (FIGS. 1 and 8) or another surface with a hook pad 196 attached.

During operation the pivoting dome 127 is pivoted by the user's side-to-side and forward-to-back body movements though its attachment to the link 109, as shown in FIGS. 1A to 6B. The pivoting dome 127 is attached to the joystick arm 139 as shown in FIGS. 16, 18, and 19. Movement of the pivoting dome 127 results in a commensurate movement of the joystick arm 139 which directly influences the electronic circuitry of the joystick 142 causing electronic positional information to be propagated to the main circuit board 157 (FIGS. 8, 16, 19, and 20) which is further propagated to the computer software 148 to be represented as control information or as up/down and left/right movements of the cursor 151 on the video display 145, shown in FIGS. 1, 7A to 7C, and 8.

The link connector 115, the pivoting dome 127, the joystick arm 139, the joystick 142, the main circuit board 157, and the trigger switch 178 (FIGS. 16, and 19) are mechanically connected to one another. During operation, when sufficient upwards pressure is applied to the link connector 115, caused by the attached elastic tether 109 being drawn upwards by body movement, the tension of the PCB springs 154 is overcome allowing the trigger switch button 181 to move away from the PCB bottom housing 184 to transfer the state of the trigger switch 178 to turn off the red LED 160, turn on the green LED 163, and electronically signal the main circuit board 157 of a state change.

Sufficient body downward movement allows the PCB springs 154 to compress the trigger switch button 181 onto the upper surface of the PCB bottom housing thus transferring the state of the trigger switch 178 to turn on the red LED 160, turn off the green LED 163, and electronically signal the main circuit board 157 of a state change.

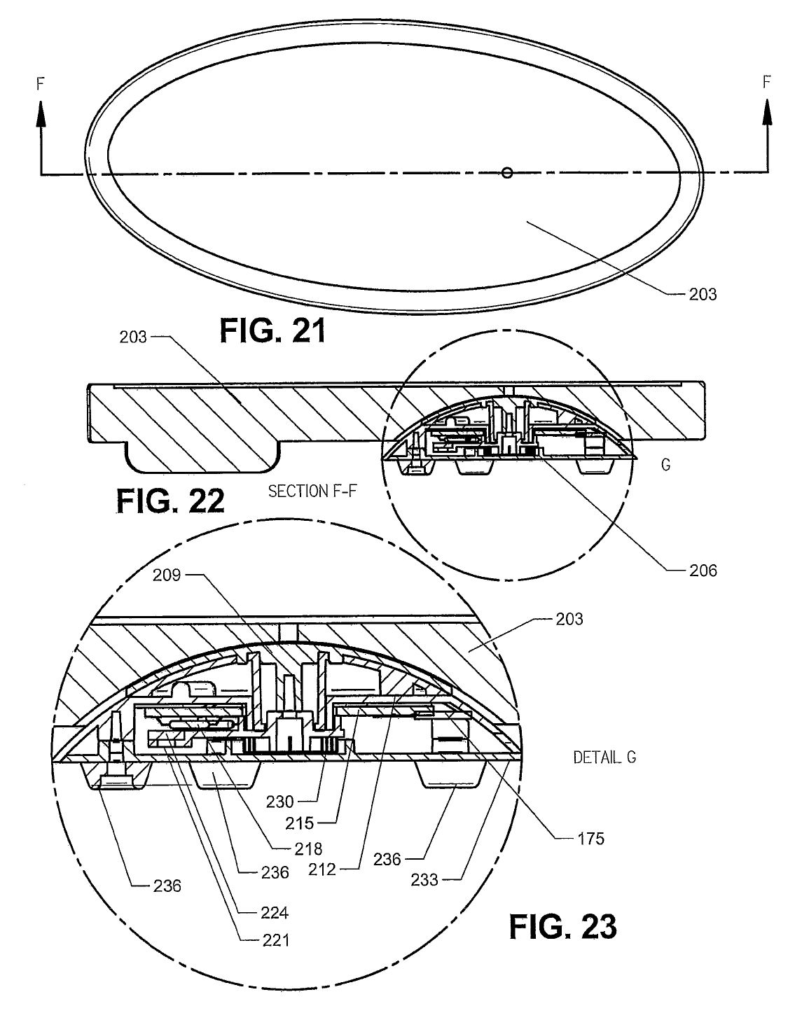

FIG. 21 is a top view of the foot adapter 203 with a cross section line F-F indicated. FIG. 22 is a cross section illustration of FIG. 21 along line F-F with a detail G highlighting the rotary input device 206. FIG. 23 illustrates a detail G of the rotary input device 206 from FIG. 22 illustrating the supporting feet 236, the bottom cover 233, the return spring 230, the magnet 224, the magnet arm 221, the reed switch 218, the circuit board 215, the housing 212, the knob 209, and the cable 175.

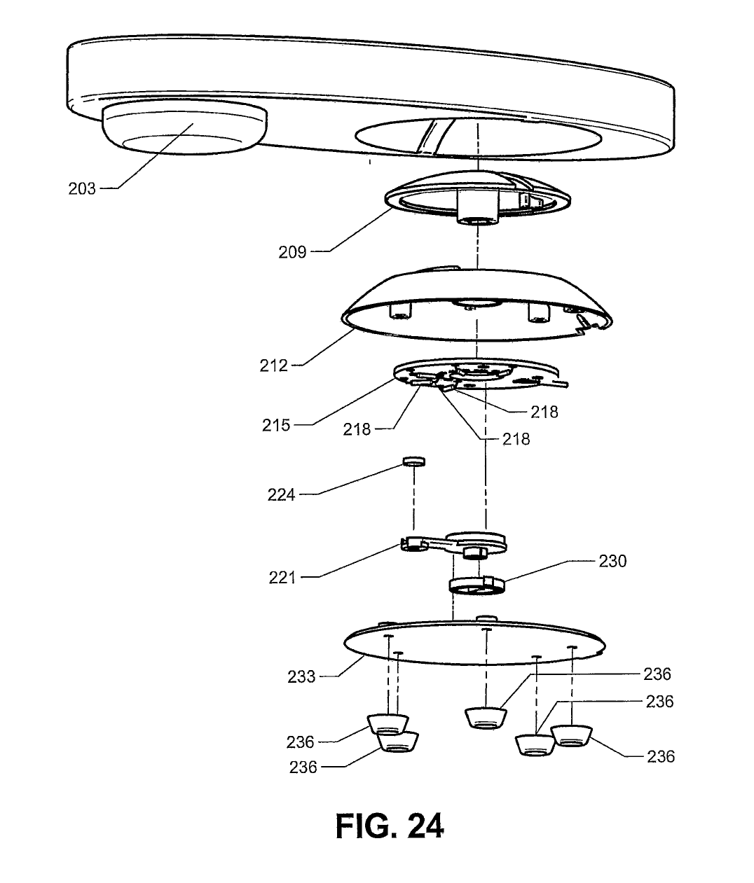

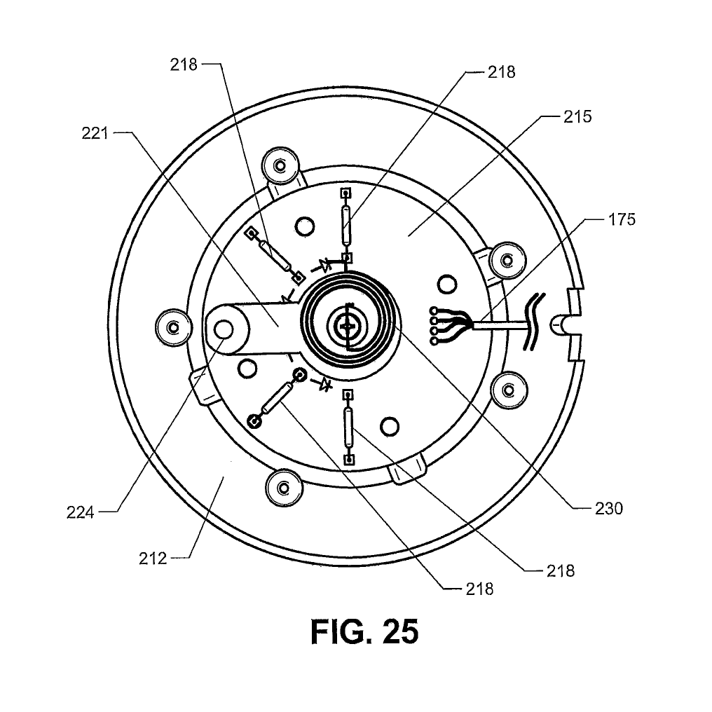

FIG. 24 illustrates an exploded view of the rotary input device 206 and the foot adapter 203. FIG. 25 represents a bottom view of the rotary input device 206 with the bottom cover 233 removed. Of note is the half-circle arrangement of the reed switches 218 being attached to the circuit board 215, with one reed switch 218 being hidden from view by the magnet arm 221. In video game playing, the user's hands or feet are rotated clockwise or counterclockwise turning the knobs 209 (not shown here but shown in FIGS. 8, 23, and 24). The knob 209 is mechanically fixed to the magnet arm 221 that embodies the magnet 224. The rotation of the user's hand thus changes the position of the magnet 224. When the magnet 224 is moved adjacent to a correspondingly positioned reed switch 218, the state of the reed switch 218 is changed, or the circuit is closed. When the magnet 224 is moved away from the correspondingly positioned reed switch 218, the state of the reed switch 218 is changed, or the circuit is opened. The return spring 230 returns the magnet arm 221, and thus the magnet 224 and the knob 209 to a set forward facing position. The cable 175 is connected to the circuit board 215 and, as indicated in FIG. 1, it is connected at its far end to the joystick control 124. The circuit board 215 provides electrical connectivity between the reed switches 218 and the cable 175.

A typical gaming joystick has a particular button or switch that performs as a trigger. This function is provided by the trigger switch 178 (FIGS. 8, 16, 19, and 20). Downward and upward motions of the body cause changes in the state of the trigger switch 178 which are reported by the main control 124 to the display software 148 (FIGS. 1, 7A to 7C, and 8) as if a user was pressing and releasing a trigger on a joystick.

Additional buttons on a gaming joystick may serve to activate different kinds of actions, possibly to intercept a target or to take aim, as in a videogame. In this invention, the reed switches 218, housed within the rotary input devices 206 (FIGS. 23 to 25), serve this purpose. Activated and deactivated by the rotational movement of the user's hands or feet, changes in the state of individual reed switches 218 are reported to the joystick control 124 for processing and then sent to the software 148 (FIGS. 1 and 8) to perform corresponding actions as if buttons were being pressed on a gaming joystick.

The preferred embodiment of the invention uses an elastic tether 109 as the operating part that interfaces with the joystick control 124 to communicate the position of the body 301. Other arrangements are also contemplated.

For example, a string-like element, much like a fishing line, attached to and spooled at its lower end onto a rotationally sprung pulley would provide a pivotal extendable link between the body 301 and the joystick control 124. Further, given the rotational nature of the pulley, a quadrature would keep track of the number of pulley turns thus emulating the trigger switch 178 in terms of keeping track of the vertical position of the user. The electronic output of the quadrature could also be interpreted by the display software 145 to establish the initial starting height of the body 301 as well as the actual distance of vertical movement during operation. This would provide a programmable means to accommodate users of differing stature as well as setting any number of downwards motion levels to essentially trigger the threshold for a trigger switch transfer.

1. An exercise control device adapted to be activated by vigorous exercises such as push-ups and leg squats for playing video games, comprising a joystick having electronic outputs for controlling the horizontal and vertical movements of a cursor on a video display, an elongated member connected at one end to said joystick and adapted to be connected at its opposite end to the body of a user whereby lateral movements of the user's body cause movement of the cursor on the screen dependent on the direction of such lateral movement, and means for sensing movement of the user's body transverse to such lateral movements, said means for sensing being connected to said joystick whereby lateral and transverse movements of the user can be used to position the cursor on the video display.

2. An exercise control device according to claim 1, including at least one manually controlled input device for producing signals for display on the video display independent of the display produced by movements of the user's body.

3. An exercise control device according to claim 2, wherein at least two of said input devices are provided.

4. An exercise control device according to claim 3, wherein said input devices each include a rotatable member and the signals produced by the input devices are dependent on the angular position of said rotatable members.

5. An exercise control device according to claim 1, wherein said elongated member comprises an elastic tether.

6. An exercise control device according to claim 5, including at least one manually controlled input device for producing signals for display on the video display independent of the display produced by movements of the user's body.

7. An exercise control device according to claim 6, wherein at least two of said input devices are provided.

8. An exercise control device according to claim 7, wherein said input devices each include a rotatable member and the signals produced by the input devices are dependent on the angular position of said rotatable members.

9. An exercise control device according to claim 8, wherein said elongated member comprises an elastic tether.
